(19) United States
(12) Patent Application Publication
(10) Pub. No.: US 2020/0400312 A1
(43) Pub. Date: Dec. 24, 2020

(54) GAS VALVE AND CONTROL DEVICE AND CONTROL METHOD THEREOF

(71) Applicant: GRAND MATE CO., LTD., TAICHUNG CITY (TW)

(72) Inventors: Chung-Chin Huang, Taichung City (TW); Chin-Ying Huang, Taichung City (TW); Hsin-Ming Huang, Taichung City (TW); Hsing-Hsiung Huang, Taichung City (TW); Yen-Jen Yeh, Taichung City (TW)

(73) Assignee: GRAND MATE CO., LTD., TAICHUNG CITY (TW)

(21) Appl. No.: 16/447,172

(22) Filed: Jun. 20, 2019

(51) Int. Cl. F23Q 9/14; F24B 1/18; F24B 1/199; F16K 31/02; F23N 1/00; F23N 5/10; F23N 5/20; F23N 5/24

(52) U.S. Cl. CPC F23Q 9/14; F24B 1/18; F24B 1/199; F16K 31/02; F23N 2035/18; F23N 5/105; F23N 5/203; F23N 5/242; F23N 2035/14; F23N 1/005

(57) ABSTRACT

The present invention provides a gas valve and a control device and a control method thereof wherein the control device receives a detection voltage generated by a thermocouple. the control device outputs the second voltage when the detection voltage generated is greater than a predetermined voltage, and then outputs the first voltage. The control device stops outputting the first voltage when receiving a shut-off signal, and the control device starts counting time and stops outputting the second voltage when the time counted reaches a predetermined time.

### BACKGROUND OF THE INVENTION

### 1. Technical Field

The present invention is related to a gas valve, and more particularly to a gas valve with a timed gas shut-off function, a control device and a control method thereof.

### 2. Description of Related Art

It is known that conventional gas fireplaces burn gas to generate heat energy and increase the temperature inside the room. FIG. 1 shows a combustion control assembly of a conventional gas fireplace, comprising a gas valve 1, an ignition electrode 9, an ignition switch 11a, an ignition circuit 11b, a main fire burner 13a, a pilot fire burner 13b, a thermocouple 15 and a main fire control switch 17. Wherein, the gas valve 1 includes a valve body 1a which has a main fire gas passage 5a and a pilot fire gas passage 5b. A main fire solenoid valve 3a and a pilot fire solenoid valve 3b are disposed inside the valve body 1a in the main fire gas passage 5a and the pilot fire gas passage 5b respectively. The valve body 1a is provided with a flow regulating valve 7 for controlling an opening degree of the main fire gas passage 5a and for opening the pilot fire solenoid valve 3b with a touch rod. When a user operates the flow regulating valve 7, the touch rod of the flow regulating valve 7 opens the pilot fire solenoid valve 3b to open the pilot fire gas passage 5b, so that the gas flows from the gas source through the pilot fire gas passage 5b to the pilot fire burner 13b.

When a user presses the ignition switch 11a, it causes the ignition circuit 11b to output a high voltage to the ignition electrode 9, so that the gas output by the pilot fire burner 13b is ignited to form a pilot fire. The thermocouple 15 in response to the flame of the pilot fire outputs a detection voltage to the pilot fire solenoid valve 3b. When the detection voltage increases to a predetermined voltage, it holds the pilot fire solenoid valve 3b to open the pilot fire gas passage 5b even without the help of the touch rod. At this time, when the main fire control switch 17 is switched on to be short-circuited by the user, the detection voltage is conducted to the main fire solenoid valve 3a, such that the main fire gas passage 5a is open to output the gas to the main fire burner 13a. The gas output from the main fire burner 13a is ignited by the pilot fire to form a main fire for heating.

When the user tries to shut off the main fire, it is only necessary to switch off the main fire control switch 17 to block the detection voltage conducted to the main fire solenoid valve 3a, so that the main fire solenoid valve 3a closes the main fire gas passage 5a.

In order to facilitate the next ignition of the main fire and respond to difficult ignition of pilot fire in low-temperature areas, conventional gas fireplaces do not extinguish the pilot fire after turning off the main fire but keep the pilot fire burning. However, the design of such gas fireplaces to keep the pilot fire burning is not only a waste of energy, but also a safety concern.

### BRIEF SUMMARY OF THE INVENTION

In view of the above, a purpose of the present invention is to provide a gas valve, a control device and a control method thereof. Wherein, the pilot fire is configured to be timed shut off at a predetermined time after the main fire is shut off.

The present invention provides a control device for a gas valve, wherein the gas valve includes a valve body, a main fire solenoid valve and a pilot fire solenoid valve. The valve body has a main fire gas passage and a pilot fire gas passage and is provided with a first control terminal and a second control terminal, wherein the first control terminal and the second control terminal are respectively electrically connected to the main fire solenoid valve and the pilot fire solenoid valve.

The main fire solenoid valve is configured to receive a first voltage through the first control terminal to open the main fire gas passage and to close the main fire gas passage when the first voltage is stopped; the pilot fire solenoid valve is configured to receive a second voltage through the second control terminal to open the pilot fire gas passage and to close the pilot fire gas passage when the second voltage is stopped.

The control device comprises a first output terminal, a second output terminal, a first input terminal, a second input terminal and a control. Wherein, the first output terminal is for connecting to the first control terminal, the second output terminal is for connecting to the second control terminal, the first input terminal is for connecting to a thermocouple to receive a detection voltage generated by the thermocouple, the second input terminal is for connecting to a main fire control switch to receive a shut-off signal generated by the main control switch, and the controller is electrically connected to the first output terminal, the second output terminal, the first input terminal and the second input terminal. The controller is configured to output the second voltage to the second output terminal when the detection voltage received by the first input terminal is greater than a predetermined voltage and then to output the first voltage to the first output terminal. The controller is configured to stop outputting the first voltage to the first output terminal when the second input terminal receives the shut-off signal, and the controller starts counting time and to stop outputting the second voltage to the second output terminal when the time counted reaches a predetermined time.

The present invention provides another gas valve, comprising a valve body, a main fire solenoid valve and a pilot fire solenoid valve. Wherein, the valve body has a main fire gas passage and a pilot fire gas passage. The main fire solenoid valve is disposed on the valve body and is configured to receive a first voltage to open the main fire gas passage and to close the main fire gas passage when the first voltage is stopped. The pilot fire solenoid valve is disposed on the valve body and is configured to receiving a second voltage to open the pilot fire gas passage and to close the pilot fire gas passage when the second voltage is stopped.

Wherein, the gas valve further comprises a control device including a first input terminal, a second input terminal and a controller. Wherein, the first input terminal is for connecting to a thermocouple to receive a detection voltage generated by the thermocouple; the second input terminal for connecting to a main fire control switch to receive a shut-off signal generated by the main fire control switch; the controller electrically connected to the main fire solenoid valve, the pilot fire solenoid valve, the first input terminal and the second input terminal.

The controller is configured to output the second voltage to the pilot fire solenoid valve when the detection voltage received by the first input terminal is greater than a predetermined voltage and then to output the first voltage to the main fire solenoid valve. The controller is configured to stop outputting the first voltage to the main fire solenoid valve when the second input terminal receives the shut-off signal, and the controller starts counting time and to stop outputting the second voltage to the pilot fire solenoid valve when the time counted reaches a predetermined time.

The present invention further provides a control method for a gas valve, wherein the gas valve comprises a valve body, a main fire solenoid valve and a pilot fire solenoid valve. The valve body has a main fire gas passage and a pilot fire gas passage. The main fire solenoid valve is disposed on the valve body and is configured to receive a first voltage to open the main fire gas passage and to close the main fire gas passage when the first voltage is stopped. The pilot fire solenoid valve is disposed on the valve body and is configured to receive a second voltage to open the pilot fire gas passage and to close the pilot fire gas passage when the second voltage is stopped. The control method performed by a controller comprises the following steps:

The controller receives a detection voltage generated by a thermocouple and to output the second voltage and the first voltage when the detection voltage generated by the thermocouple is greater than a predetermined voltage. The controller stops outputting the first voltage when receiving a first shut-off signal, and the controller starts counting time and to stop outputting the second voltage when the time counted reaches a predetermined time.

The advantage of the present invention is to shut off the pilot fire by automatically closing the pilot fire gas passage by the controller after closing the main fire gas passage and reaching a predetermined time. In this way, not only can the waste of energy caused by the continuous combustion of the pilot fire be avoided, but also can accidents such as fires be prevented.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of a conventional gas fireplace;

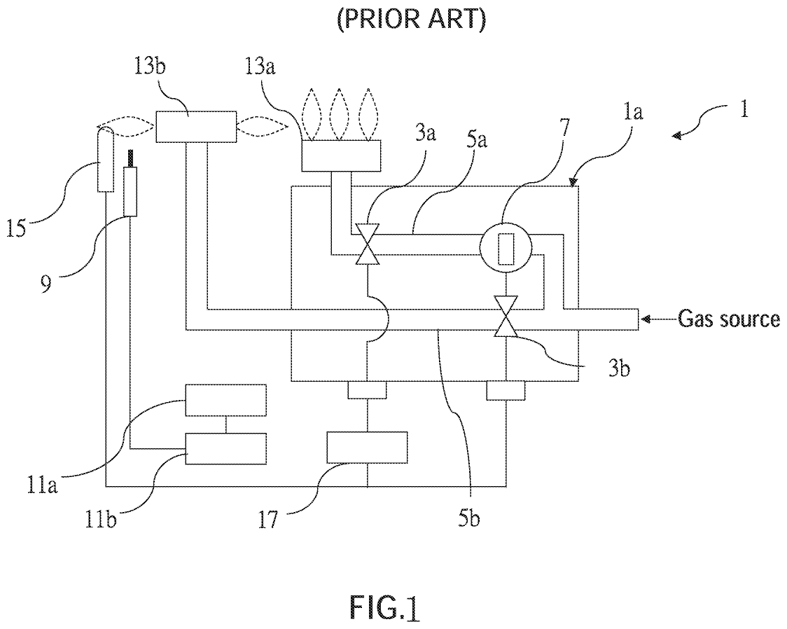

FIG. 2 is a schematic view of a gas valve and a control device thereof of a first embodiment according to the present invention;

FIG. 3 is a flow chart of a control method of the first embodiment;

FIG. 4 is a schematic view of a gas valve and a control device thereof of a second embodiment; and

FIG. 5 is a schematic view of a gas valve and a control device thereof of a third embodiment.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

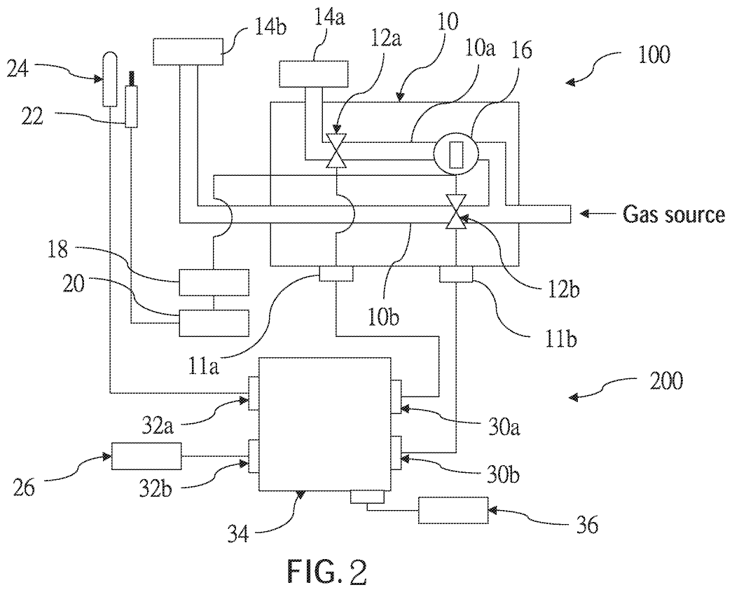

FIG. 2 shows a first preferred embodiment of a gas valve 100 and a control device 200 according to the present invention, wherein the gas valve 100 and the control device 200 are used for a fireplace, but not limited thereto, and can be any gas heating devices.

As illustrated in FIG. 2, a gas valve 100 comprises a valve body 10, a main fire solenoid valve 12a and a pilot fire solenoid valve 12b. The valve body 10 has a main fire gas passage 10a and a pilot fire gas passage 10b in which the main fire gas passage 10a communicates with the pilot fire gas passage 10b to the same gas source. The main fire gas passage 10a is connected to a main fire burner 14a at an end remote from the gas source while the pilot fire gas passage 10b is connected to a pilot fire burner 14b at an end remote from the gas source. The main fire solenoid valve 12a is disposed on the main fire gas passage 10a between the gas source and the main fire burner 14b, and the pilot fire solenoid valve 12b is disposed on the pilot fire gas passage 10b between the gas source and the pilot fire burner 14b. The main fire solenoid valve 12a and the pilot fire solenoid valve 12b in the present embodiment are normally closed solenoid valves that are open or closed by voltage control. When the solenoid valve is open, the gas passes; when the solenoid valve is closed, the gas is blocked.

The valve body 10 is provided with a first control terminal 11a and a second control terminal 11b, wherein the first control terminal 11a and the second control terminal 11b are respectively electrically connected to the main fire solenoid valve 12a and the pilot fire solenoid valve 12b. The main fire solenoid valve 12a is configured to receive a first voltage through the first control terminal 11a to open the main fire gas passage 10a. The first voltage is at a high level. When the first voltage is stopped, the first voltage drops to a low level, and the main fire solenoid valve 12a closes the main fire gas passage 10a. The pilot fire solenoid valve 12b is configured to receive a second voltage to open the pilot fire gas passage 10b. The second voltage is at a high level. When the second voltage is stopped, the second voltage drops to a low level, and the pilot fire solenoid valve 12b closes the pilot fire gas passage 10b.

The valve body 10 is provided with a flow regulating valve 16 for regulating a gas flow passing through the main fire gas passage 10a. The flow regulating valve 16 includes a touch rod (not shown in the figure) for opening the pilot fire solenoid valve 12b to open the pilot fire gas passage 10b, so that the gas flows through the pilot fire gas passage 10b to the pilot fire burner 14b. When the flow regulating valve 16 is rotated, it activates an ignition switch 18 simultaneously. In other embodiments, the ignition switch 18 can also be pressed by a user to be activated. When the ignition switch 18 is activated, an ignition circuit 20 is triggered to output a high voltage to an ignition electrode 22, so that the ignition electrode 22 generates sparks and ignites the gas output from the pilot fire burner 14b to generate a pilot fire thereby.

A thermocouple 24 in response to the pilot fire is disposed by the pilot fire burner 14b and outputs a corresponding detection voltage. When the detection voltage gradually increases to a predetermined voltage, it holds the pilot fire solenoid valve to be open. At this time, the user releases the flow regulating valve 16 and the pilot fire solenoid valve 12b remains open.

The control device 200 comprises a first output terminal 30a, a second output terminal 30b, a first input terminal 32a, a second input terminal 32b and a controller 34. The controller 34 is a microcontroller unit (MCU) that is electrically connected to the first output terminal 30a, the second output terminal 30b, the first input terminal 32a and the second input terminal 32b. The first output terminal 30a is connected to the first control terminal 11a, the second output terminal 30b is connected to the second control terminal 11b, the first input terminal 32a is connected to the thermocouple 24, and the second input terminal 32b is connected to a main fire control switch 26. When the detection voltage of the thermocouple 24 output to the first input terminal 32a continues to increase to a predetermined voltage, the controller 34 receives a power from the thermocouple 24 to maintain operation and to output the second voltage to the second output terminal 30b.

The pilot fire solenoid valve 12b receives the second voltage through the second control terminal 11b to keep the pilot fire gas passage 10b open, and meanwhile the controller 34 outputs the first voltage to the first output terminal 30a. The main fire solenoid valve 12a receives the first voltage through the first control terminal 11a to open the main fire gas passage 10a, such that the gas flows through the main fire gas passage 10a to the main fire burner 14a and is ignited by the pilot fire of the pilot fire burner 14b, resulting in a main fire generated by the main fire burner 14a. In one embodiment, the control device 200 can be attached to the valve body 10, such as by means of screwing in, gluing, welding.

In the current embodiment, a shut-off signal is generated when the user presses the main fire control switch 26. The controller 34 stops outputting the first voltage to the first output terminal 30a when the second input terminal 32b receives the shut-off signal, so that the main fire solenoid valve 12a closes the main fire gas passage 10a. Meanwhile, the controller 34 starts counting time and stops outputting the second voltage to the second output terminal 30b when the time counted reaches a predetermined time, so that the pilot fire solenoid valve 12b closes the pilot fire gas passage 10b and extinguishes the pilot fire.

In the current embodiment, the predetermined time is seven days; that is, the controller 34 controls the pilot fire solenoid valve 12b to close the pilot fire gas passage 10b after the main fire solenoid valve 12a closes the main fire gas passage 10a for seven days. In one embodiment, the user can customize the predetermined time and save in the controller 34.

However, when the main fire solenoid valve 12a closes the main fire gas passage 10a, the user presses the main fire control switch 26 to generate a turn-on signal. The controller 34 stops counting time and then outputs the first voltage to the first output terminal 30a when the second input terminal 32b receives the turn-on signal and the time counted by the controller 34 has not reached the predetermined time. The main fire solenoid valve 12a receive the first voltage through the first control terminal 11a to open the main fire gas passage 10a, so that the gas flows through the main fire gas passage 10a to the main fire burner 14a and is ignited by the pilot fire of the pilot fire burner 14b to generate the main fire of the main fire burner 14a.

In the current embodiment, the control device 200 further comprises a pilot fire indicator 36 electrically connected to the controller 34 that configured to control the pilot fire indicator 36 to light up when the second voltage is output to the second output terminal 30b and to control the pilot fire indicator 36 to extinguish when the time counted reaches the predetermined time. The pilot fire indicator 36 can be an LED light which can be disposed at a position that is easy for the user to see. The user is able to know the current state of the pilot fire by whether the pilot fire indicator 36 is on or off.

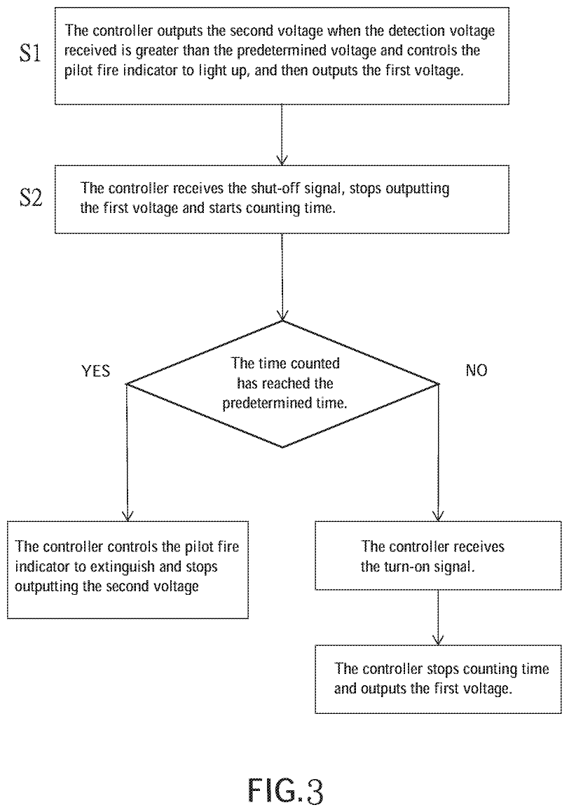

With the structure of the gas valve 100 and the control device 200, the control method for the gas valve 100 of the present embodiment can be performed and comprises the following steps shown in FIG. 3.

First, in step S1, the controller 34 receives the detection voltage generated by the thermocouple 24. The controller 34 outputs the second voltage when the detection voltage generated by the thermocouple is greater than the predetermined voltage, and then outputs the first voltage. In the current embodiment, after the pilot fire generated by the pilot fire burner 14b, the controller 34 receives the detection voltage generated by the thermocouple 24. When the detection voltage is greater than the predetermined voltage, the controller 34 receives the power from the thermocouple 24 to maintain operation, and outputs the second voltage to the pilot fire solenoid 12b so the pilot fire gas passage 10b keeps to be open, and then outputs the first voltage to the main fire solenoid valve 12a so the main fire gas passage 10a keeps to be open, so that the gas output by the main fire burner 14a is ignited by the pilot fire to form the main fire.

In step S2, the controller 34 stops outputting the first voltage and starts counting time after receiving the shut-off signal. When the time counted reaches the predetermined time, the controller 34 stops outputting the second voltage. In the current embodiment, when the user presses the main fire control switch 26, it causes the main fire control switch 26 to output the shut-off signal to the controller 34. The controller 34 stops outputting the first voltage to the main fire solenoid 12a after receiving the shut-off signal, so that the main fire gas passage 10a is closed and the main fire is extinguished thereby. Meanwhile, the controller 34 starts counting time. When the time counted reaches the predetermined time, the second voltage is stopped outputting to the pilot fire solenoid 12b, so that the pilot fire gas passage 10b is closed and the pilot fire is extinguished thereby.

In step S1, it is further included that the controller 34 controls the pilot fire indicator 36 to light up when outputting the second voltage, while, in step S2, the controller 34 controls the pilot fire indicator 36 to extinguish when the time counted reaches the predetermined time.

In the current embodiment, it is further included that when the time counted by the controller 34 has not reached the predetermined time, the user presses the main fire control switch 26 and causes the main fire control switch 26 to output the turn-on signal to the controller 34. The controller 34 stops counting time and outputs the first voltage to the main fire solenoid valve 12a after receiving the turn-on signal, so that the main fire gas passage 10a is open.

Whereby, the controller automatically closes the pilot fire gas passage to extinguish the pilot fire when reaching the predetermined time. In this way, not only can the waste of the energy caused by continuous combustion of the pilot fire be avoided, but also accidents such as fires can be prevented.

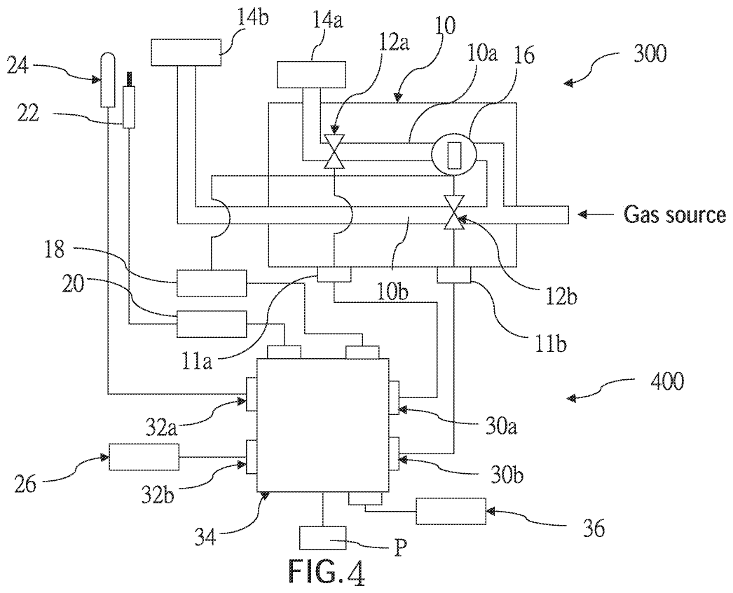

A gas valve 300 and a control device 400 of a second preferred embodiment of the present invention is shown in FIG. 4, wherein the gas valve 300 and the control device 400 include structures which are similar to the gas valve 100 and the control device 200 of the first preferred embodiment, except that the ignition switch 18 and the ignition circuit 20 are respectively electrically connected to the controller 34 that is electrically connected to a power source P (such as a DC power supply or a battery).

Before ignition, the controller 34 receives a power supplied by the power source P to operate. When the user rotates the flow regulating valve 16 to an ignition position, the pilot fire solenoid valve 12b is open by the touch rod and thereby the pilot fire gas passage 12b is open, and the flow regulating valve 16 causes the ignition switch 18 to be activated simultaneously to output an ignition signal to the controller 34. When the controller 34 receives the ignition signal, the controller 34 triggers the ignition circuit 20 to output a high voltage to the ignition electrode 22 so that the ignition electrode 22 generates sparks. Meanwhile, the controller 34 outputs the second voltage to the second output terminal 30b simultaneously and continues to output the second voltage. The pilot fire solenoid valve 12b receives the second voltage through the second control terminal 11b to keep the pilot fire gas passage 10b open. At this time, the user releases the flow regulating valve 16 and the pilot fire solenoid valve 12b remains open.

The control method for the gas valve in the current embodiment can also follow the steps of the control method of the first embodiment, except that the controller 34 receives the power supplied by the power source P to maintain operation and to output the second voltage before the controller 34 receives the detection voltage of the thermocouple 24. When the detection voltage generated by the thermocouple 24 is greater than the predetermined voltage, the controller 34 turns to receive the power supplied by the thermocouple 24 to maintain operation and to output the second voltage and the first voltage but not utilize the power supplied by the power source P. The controller turns to receive the power supplied by the power source P until the detection voltage generated by the thermocouple 24 is less than the predetermined voltage.

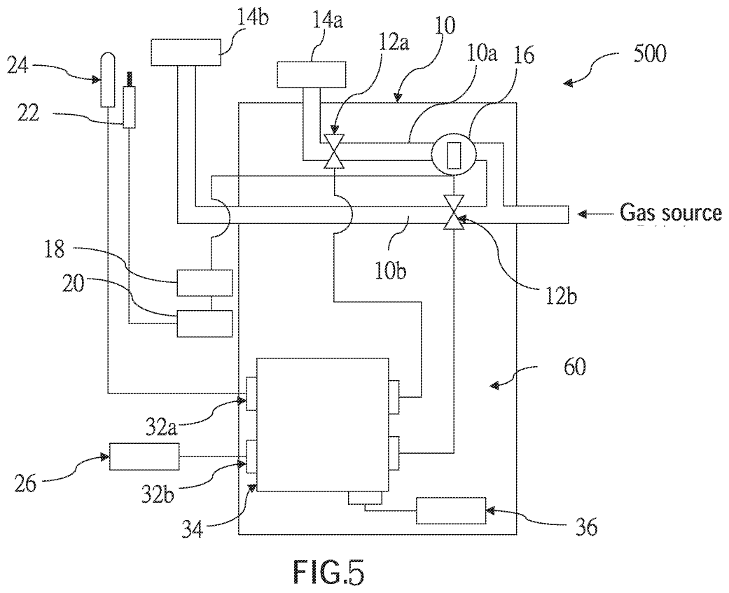

A gas valve 500 of the third preferred embodiment according to the present invention is shown in FIG. 5. The difference from the first embodiment is that a control device 60 is attached to the valve body 10 of the gas valve 500 in the current embodiment. That is, the gas valve 500 comprises the valve 10 and the control device 60, and the controller 34 electrically connected to the main fire solenoid valve 12a and the pilot fire solenoid valve 12b directly without the first control terminal 11a and the second control terminal 11b of the first embodiment. The controller 34 outputs the second voltage to the pilot fire solenoid valve 12b when the detection voltage received by the first input terminal 32a is greater than the predetermined voltage, and then outputs the first voltage to the main fire solenoid valve 12a.

The control method for the gas valve 500 in the current embodiment can also follow the steps of the control method of the first embodiment.

To summary up, the gas valve and the control device and the control method thereof of the invention are described as above. After the main fire gas passage 10a is closed, the controller 34 automatically closes the pilot fire gas passage 10b when reaching the predetermined time. Thereby, not only can the waste of energy be avoided, but also can accidents such as fires be prevented, so as to increase the safety of the user in using the gas valve.

It must be pointed out that the embodiments described above are only some embodiments of the present invention. All equivalent structures which employ the concepts disclosed in this specification and the appended claims should fall within the scope of the present invention.

What is claimed is:

1. A control device for a gas valve, wherein the gas valve includes a valve body, a main fire solenoid valve and a pilot fire solenoid valve; the valve body having a main fire gas passage and a pilot fire gas passage and being provided with a first control terminal and a second control terminal, wherein the first control terminal and the second control terminal are respectively electrically connected to the main fire solenoid valve and the pilot fire solenoid valve; the main fire solenoid valve configured to receive a first voltage through the first control terminal to open the main fire gas passage and to close the main fire gas passage when the first voltage is stopped; the pilot fire solenoid valve configured to receive a second voltage through the second control terminal to open the pilot fire gas passage and to close the pilot fire gas passage when the second voltage is stopped; the control device comprising:
a first output terminal for connecting to the first control terminal;
a second output terminal for connecting to the second control terminal;
a first input terminal for connecting to a thermocouple to receive a detection voltage generated by the thermocouple;
a second input terminal for connecting to a main fire control switch to receive a shut-off signal generated by the main control switch;
a controller electrically connected to the first output terminal, the second output terminal, the first input terminal and the second input terminal, wherein the controller is configured to output the second voltage to the second output terminal when the detection voltage received by the first input terminal is greater than a predetermined voltage and then to output the first voltage to the first output terminal; the controller configured to stop outputting the first voltage to the first output terminal when the second input terminal receives the shut-off signal, and the controller starts counting time and stops outputting the second voltage to the second output terminal when the time counted reaches a predetermined time.

2. The control device for the gas valve of claim 1, further comprising a pilot fire indicator electrically connected to the controller and configured to control the pilot fire indicator to light up when the second voltage is output to the second output terminal and to control the pilot fire indicator to extinguish when the time counted reaches the predetermined time.

3. The control device for the gas valve of claim 1, wherein the second input terminal is for receiving a turn-on signal generated by the main fire control switch; wherein, the controller is configured to stop counting time and to output the first voltage to the first output terminal when the second input terminal receives the turn-on signal and the time counted has not reached the predetermined time.

4. A gas valve, comprising:
a valve body having a main fire gas passage and a pilot fire gas passage;
a main fire solenoid valve disposed on the valve body and configured to receive a first voltage to open the main fire gas passage and to close the main fire gas passage when the first voltage is stopped;
a pilot fire solenoid valve disposed on the valve body and configured to receive a second voltage to open the pilot fire gas passage and to close the pilot fire gas passage when the second voltage is stopped;
characterized in that the gas valve further comprises a control device including:
a first input terminal for connecting to a thermocouple to receive a detection voltage generated by the thermocouple;
a second input terminal for connecting to a main fire control switch to receive a shut-off signal generated by the main fire control switch;
a controller electrically connected to the main fire solenoid valve, the pilot fire solenoid valve, the first input terminal and the second input terminal, wherein the controller is configured to output the second voltage to the pilot fire solenoid valve when the detection voltage received by the first input terminal is greater than a predetermined voltage and then to output the first voltage to the main fire solenoid valve; the controller configured to stop outputting the first voltage to the main fire solenoid valve when the second input terminal receives the shut-off signal, and the controller starts counting time and stops outputting the second voltage to the pilot fire solenoid valve when the time counted reaches a predetermined time.

5. The gas valve of claim 4, wherein the control device is attached to the valve body.

6. The gas valve of claim 4, wherein the control device further comprises a pilot fire indicator electrically connected to the controller and is configured to control the pilot fire indicator to light up when the controller outputs the second voltage to the pilot fire solenoid valve and to control the pilot fire indicator to extinguish when the time counted reaches the predetermined time.

7. The gas valve of claim 4, wherein the second input terminal is for receiving a turn-on signal generated by the main fire control switch; wherein the controller is configured to stop counting time and to output the first voltage to the main fire solenoid valve when the second input terminal receives the turn-on signal and the time counted has not reached the predetermined time.

8. A control method for a gas valve, wherein the gas valve comprises a valve body, a main fire solenoid valve and a pilot fire solenoid valve; the valve body having a main fire gas passage and a pilot fire gas passage, the main fire solenoid valve disposed on the valve body and configured to receive a first voltage to open the main fire gas passage and to close the main fire gas passage when the first voltage is stopped; the pilot fire solenoid valve disposed on the valve body and configured to receive a second voltage to open the pilot fire gas passage and to close the pilot fire gas passage when the second voltage is stopped; the control method, performed by a controller, comprising the following steps:
the controller receives a detection voltage generated by a thermocouple and outputs the second voltage and the first voltage when the detection voltage generated by the thermocouple is greater than a predetermined voltage;
the controller stops outputting the first voltage when receiving a shut-off signal, and the controller starts counting time;
the controller stops outputting the second voltage when the time counted reaches a predetermined time.

9. The control method for the gas valve of claim 8, further comprising that the controller controls a pilot fire indicator to light up when outputting the second voltage and to control the pilot fire indicator to extinguish when the time counted reaches the predetermined time.

10. The control method for the gas valve of claim 9, further comprising that the controller stops counting time and outputs the first voltage when receiving a turn-on signal and the time counted has not reached the predetermined time.

11. The control method for the gas valve of claim 9, further comprising that the controller receives a power of a power supply to output the second voltage before the controller receives the detection voltage generated by the thermocouple; and the controller receives a power from the thermocouple to output the second voltage and the first voltage when the detection voltage generated by the thermocouple is greater than the predetermined voltage.
